(19) United States
(12) Patent Application Publication
(10) Pub. No.: US 2022/0395920 A1
(43) Pub. Date: Dec. 15, 2022

(54) THREADING METHOD

(71) Applicant: Tornos SA, Moutier (FR)

(72) Inventor: Marco Dolci, Bévilard (CH)

(21) Appl. No.: 17/835,112

(22) Filed: Jun. 8, 2022

(30) Foreign Application Priority Data
Jun. 9, 2021 (EP) 21178605

(51) Int. Cl. B23G 1/04; B23G 5/08

(52) U.S. Cl. CPC B23G 1/04; B23G 5/08; B23G 2240/36; B23G 2210/04; B23G 2210/08

(57) ABSTRACT

The invention relates to a method of making a thread or tap on a cylindrical, conical or frustoconical piece to be machined.

According to the invention, this method comprises the steps of:
a) driving in rotation the piece to be machined in one direction),
b) carrying out a relative displacement of a first cutting edge of a tool relative to the piece to be machined until this first cutting edge is flush with the surface to be threaded of the workpiece at the beginning of the section to be threaded,
c) carrying out a relative displacement of the tool relative to the piece to be machined so that the first cutting edge machines the piece to be machined,
d) carrying out a relative displacement of the tool along the longitudinal axis of the piece to be machined, in one direction until the end of the section to be threaded,
e) moving away, by a relative displacement, the first cutting edge of the tool from the piece to be machined,
   and it has the particularity of further comprising the steps of:
f) reversing the rotation of the piece to be machined to drive this piece in rotation in the direction opposite to the direction, while positioning or not the second cutting edge,
g) moving, by relative displacement, a second cutting edge towards the piece to be machined until this second cutting edge penetrates the thread pitch,
h) carrying out a relative displacement of the second cutting edge relative to the workpiece so that it continues the machining of the thread in the piece to be machined,
i) carrying out a relative displacement of the second cutting edge in a direction opposite to the direction, until the beginning of the section to be threaded,
j) moving, by a relative displacement, the second cutting edge away from the workpiece to be machined,
k) reversing the rotation of the piece to be machined, while positioning or not the first cutting edge then
l) repeating steps b) to k), while continuing the machining of the thread, until the thread reaches its final dimensions, while positioning the first cutting edge in step b) in such a way that it penetrates the thread pitch already machined.

### TECHNICAL FIELD

The present disclosure concerns a method of producing an internal or external thread on a cylindrical, conical or frustoconical surface to be machined of a turned part, in particular a piece cut from a turning bar.

### STATE OF THE ART

In turning, “threading” is generally understood as the operation of making a thread on the face of a cylinder, cone or frustum.

The thread considered as a whole is also called “threading”. This threading is sometimes called “external threading”, as opposed to “internal threading”, made by machining a thread inside a cylindrical part, a cone or a frustum. This internal machining operation is itself sometimes called “tapping”.

In the prior art, to make an external thread, a tool called a “cutting tool” is used, with which a succession of passes is made in the material of a workpiece, adjusting the feed of the longitudinal axis to the rotation of the spindle or the chuck. At the end of each machining pass, the cutting tool disengages from the workpiece by a withdrawal movement, performs a relative displacement substantially parallel to the surface it has just machined to reposition itself at the starting point; it then approaches the center of rotation of the workpiece in relation to the previous pass, synchronizes in a fraction of a second to fall back into the thread pitch and launches the next pass. This is repeated until a depth of cut is reached that makes the thread on the workpiece conform to the size and appearance requirements. During the whole operation, the spindle keeps turning at the same speed and in the same direction.

For an internal thread, the main difference is that the center of rotation of the workpiece is moved further as consecutive passes are made.

This is moreover historically the main reason for making these threads in this way. Until the recent use of motorized spindles as a drive system for bar turning parts, reversing the direction of rotation of the workpiece took longer than the time required for the return of the cutting tools to empty space to reposition themselves. But the much greater dynamics of motorized spindles, which have been introduced in series in today's machines for other reasons, had not yet led to a reflection on the threading process.

The implementation of threading operations of the prior art regularly represents a large part of the machining time for turned pieces, in particular of pieces cut from a turning bar.

Today, there are specific thread whirling machines that make it possible to reduce threading times. This involves a preliminary investment, a start-up and a longer adjustment when changing pieces. And above all, certain space constraints do not allow these devices to be used for all surfaces to be threaded.

When producing threading, numerous parameters must be taken into account, notably:
the direction of the thread (right pitch or left pitch),
the number of passes,
the height or depth of the passes,
the dimensions of the thread (diameter, length, conical, . . . )
the thread pitch,
the mode and angle of penetration of the tool into the material, and
the direction of machining (direction of material removal).

### SUMMARY

A main object of the present disclosure is to reduce the cycle time for producing a thread and thus to allow a higher production rhythm of machined pieces, thus reducing production costs.

This main object is attained by means of a method for producing a thread on a cylindrical, conical or frustoconical workpiece, comprising the steps of:

a) driving in rotation the piece to be machined in one direction A,

b) carrying out a relative displacement of a first cutting edge of a tool relative to the piece to be machined until this first cutting edge is flush with the surface to be threaded of the workpiece to be machined, at the beginning of the section to be threaded,

c) carrying out a relative displacement of the tool relative to the piece so that the first cutting edge machines the piece to be machined,

d) carrying out a relative displacement of the tool along the longitudinal axis of the piece to be machined, in one direction L until the end of the section to be threaded,

e) moving away, by a relative displacement, the first cutting edge of the tool from the piece to be machined,

f) reversing the rotation of the piece to be machined to drive this piece in rotation in the direction B opposite to the direction A, while positioning or not the second cutting edge,

g) moving, by relative displacement, a second cutting edge towards the piece to be machined until this second cutting edge penetrates the thread pitch,

h) carrying out a relative displacement of the second cutting edge relative to the workpiece so that it continues the machining of the thread in this piece,

i) carrying out a relative displacement of the second cutting edge in a direction M opposite to the direction L, until the beginning of the section to be threaded,

j) moving, by a relative displacement, the second cutting edge away from the piece to be machined,

k) reversing the rotation of the piece to be machined, while positioning or not the first cutting edge then

l) repeating steps b) to k), while continuing the machining of the thread, until the thread reaches its final dimensions, while positioning the first cutting edge in step b) in such a way that it penetrates the thread pitch already machined.

Thanks to such a method, and depending on various non-exclusive parameters such as material and length of the section to be threaded, it is possible to reduce the time required for threading by 5 to nearly 45% compared to the methods known from the prior art. Indeed, producing the thread along both directions of translation of the threading tool in relation to the workpiece to be machined makes it possible to avoid the need for the tool to make an idle movement to return to the beginning of the section to be threaded.

In a first preferred embodiment, the first and second cutting edges are located on the same tool. This makes it possible to reduce even further the time required for threading because the time required for tool change is minimized.

In a second preferred embodiment, the first cutting edge is located on a first tool and the second cutting edge on a second tool. This allows the tools to approach the workpiece from two different sides, which also makes it possible to reduce machining time while using standard commercial cutting edges.

In another preferred embodiment, the first tool is carried by a first tool holder and the second tool is carried by a second tool holder. Not all machines offer this opportunity, which is very interesting for distributing the chip flow.

In a next preferred embodiment, the first tool holder and the second tool holder are mounted on the same tool set.

In still another preferred embodiment, the first tool holder is mounted on a first tool set and the second tool holder is mounted on a second tool set.

In a next preferred embodiment, a third tool with a third cutting edge and a fourth tool with a fourth cutting edge are provided on a second tool set, the first and third tools operating simultaneously and in the same manner, just as do the second and fourth tools.

In another preferred embodiment, in the case of a conical or frustoconical workpiece, the piece to be machined is immobile axially and the axial displacement in the direction of the tool is accompanied by a radial movement towards the central longitudinal axis of the workpiece to be machined and the axial displacement in the direction of the tool is accompanied by a radial movement away from the central longitudinal axis of the workpiece to be machined.

The method according to the invention offers in general the following advantages:
a reduction of interventions to change the tool (cutting tool or tap),
a decrease in tool heating,
application of an identical force on both sides of the thread (oppositional cut),
a reduction of burrs at the entry and exit of the threading/tapping and/or
removal of a possible pile of chips during the return pass.

### BRIEF DESCRIPTION OF THE DRAWINGS

FIG. 1: the steps for producing a thread according to a prior art;

FIGS. 2a and 2b: the steps common to a threading of the prior art and to a threading according to a first embodiment of the invention;

FIGS. 3 to 5: successive steps of the method according to the first embodiment the invention;

FIGS. 6 to 10: tool systems implementing the method according to the first embodiment of the invention for producing a thread;

FIG. 10: the production of an internal thread according to a second embodiment of the invention; and

FIG. 11: a detail of a tool for producing the tapping of FIG. 10.

### DETAILED DESCRIPTION

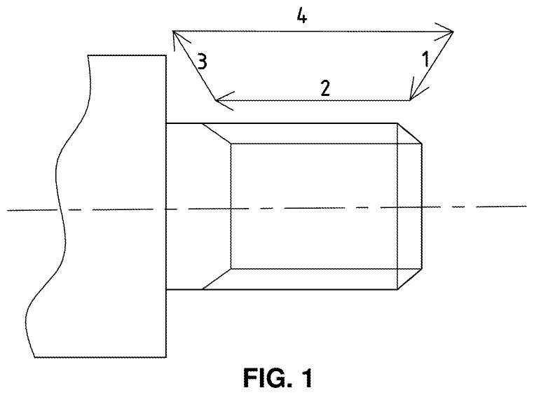

Represented in FIG. 1 is a method for threading a piece according to the prior art. The numbers indicate the movements of the cutting tool in chronological order, that is globally:
1: the approach of the piece to be machined and coming into contact with the material;
2: the movement along the longitudinal axis of the piece;
3: moving away of the piece; and
4: back to the beginning of the thread and back to step 1.

The principle of the method according to the present disclosure is quite different. It lies in the fact that the material is removed in both directions, following a longitudinal movement corresponding to the axis generally designated by Z− or Z+.

This prevents the tool from making an empty trip to return to the beginning of the section to be threaded.

According to the present disclosure, when the tool is at the end of the thread, it is necessary to change the cutting edge—because the cut is going to be made in the other direction of rotation—to reverse the direction of rotation of the spindle or chuck, then machine by returning to the beginning of the thread, and so on between each pass.

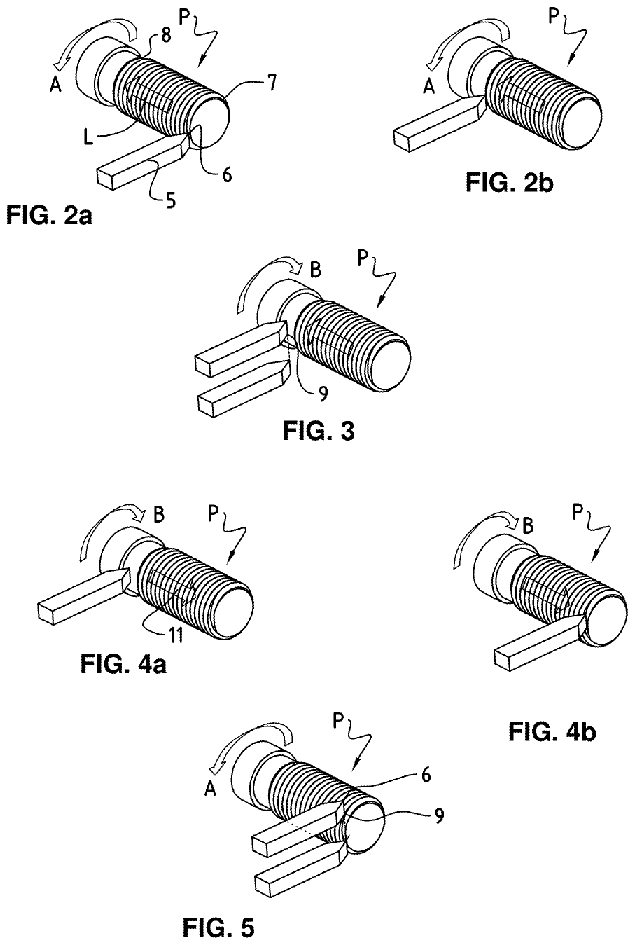

A first embodiment of the invention is represented in FIGS. 2 to 5. It is implemented on a numerically controlled lathe.

Steps 2a and 2b correspond to steps common to the prior art and the first embodiment of the invention.

As can be seen in FIG. 2a, one begins by driving the piece to be machined P in rotation in direction A, then a tool 5, such as a cutting tool, is brought close to the workpiece P, so that its cutting edge 6 is flush with the surface to be threaded of the workpiece to be machined, at the beginning 7 of the section to be threaded, which corresponds in FIG. 2a to the free end of the workpiece P.

Then, the cutting tool 5 is displaced radially so that the edge 6 penetrates into the material to machine the piece P. The cutting tool is displaced in the direction L along the longitudinal axis of the piece P, to the end 8 of the section to be threaded. We are then in the situation corresponding to FIG. 2b. By radially, we refer here to the cross section of the piece P.

In FIG. 2a, the piece P is axially immobile and it is the cutting tool 5 that moves. In a variant, the tool 5 could be fixed and one could displace the piece P along its longitudinal axis, in the direction M opposite to the direction L.

As soon as the cutting tool 5 has arrived at the end 8 of the section to be threaded, it is moved away from the piece P.

Starting from that moment, the realization of the thread according to the first embodiment of the invention starts to differ from the threading of the prior art.

In accordance with the present disclosure, the direction of rotation of the piece P must be reversed.

As can be seen in FIG. 3 and in keeping with the first embodiment of the invention, the cutting tool 5 used comprises a second cutting edge 9 situated at its lower vertical end, its first cutting edge 6 being located at its upper vertical end.

The moving away of the cutting tool 5 from the workpiece P is thus achieved by moving this cutting tool vertically upwards, so that its first edge 6 also moves vertically away from the workpiece P. At the same time, its second edge 9 comes into working position, i.e. so that it is situated horizontally at the same level as the axis of rotation R of the piece P.

Then, the rotation of the piece P is stopped, then this piece P is driven in rotation in the direction B opposite to the direction A.

To save time, the rotation is stopped as soon as the tool is far enough away from the piece P.

Once the second edge 9 is at the right height, it is moved towards the piece P following a radial displacement, with a suitable positioning so that it penetrates the thread pitch.

The positioning must be extremely precise so that the edge is inserted exactly between two walls of this thread and does not destroy it. Such indexing is preferably calculated by the software controlling the CNC lathe.

Then, the second edge 9 is displaced further radially in order to resume machining of the thread. At the same moment, as can be seen in FIG. 4a, the tool P is moved in the direction M opposite to the direction L, to the beginning 7 of the section to be threaded, the piece P being axially immobile.

As before, the cutting tool 5 could be fixed and the piece P could be moved along its longitudinal axis, in the direction M opposite to the direction L.

Represented in FIG. 4b is the situation where the cutting tool burin 5 arrives at the beginning 7 of the section to be threaded.

Then, as can be seen in FIG. 5, the cutting tool is moved away from the piece P by vertical displacement, downwards this time.

Its second edge 9 thus also moves away vertically from the piece P and at the same time, the first cutting edge 6 comes into working position, i.e. so that it is situated horizontally at the same level as the axis of rotation R of the piece P.

Then the rotation is stopped so that the piece P is ready for rotation in the other direction, direction A.

The operations can then resume at the stage of FIG. 2a.

This is repeated until the thread reaches its final dimensions.

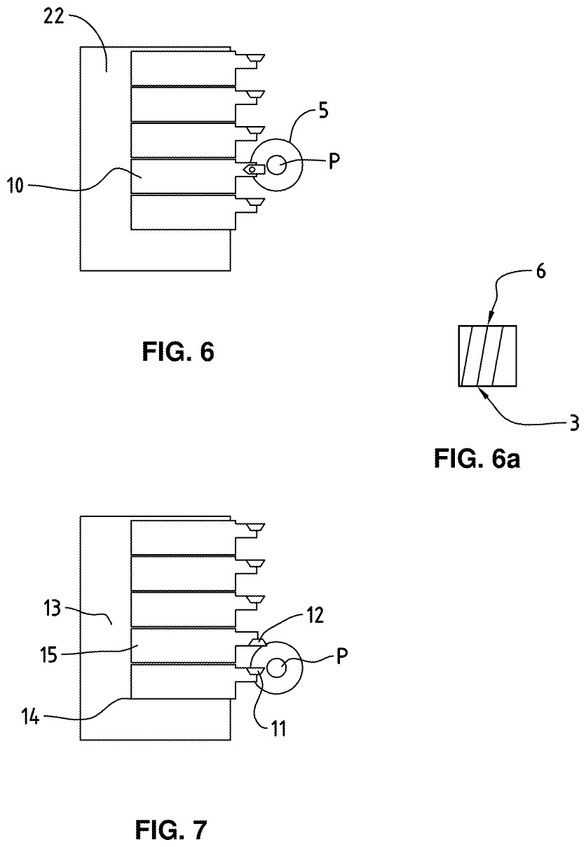

As can be seen from FIG. 6, the cutting tool 5 can be mounted on a tool holder 10, itself being supported by a tool system 22.

FIG. 6b is, showing the tool in front view, shows a configuration of the first and second cutting edges 6, 9 of the cutting tool 5 in FIG. 6.

However, the first and second edges 6, 9 are not necessarily located on the same tool. They can be on different tools.

Represented in FIG. 7 is a tool system 13, comprising a plurality of tool holders 14, 15. At least two tools 11, 12 are provided for producing a thread, the first cutting edge being located then on a first tool 11 and the second cutting edge on a second tool 12. The passage from the first cutting edge to the second cutting edge is carried out by means of a vertical translation downward of the second tool 12.

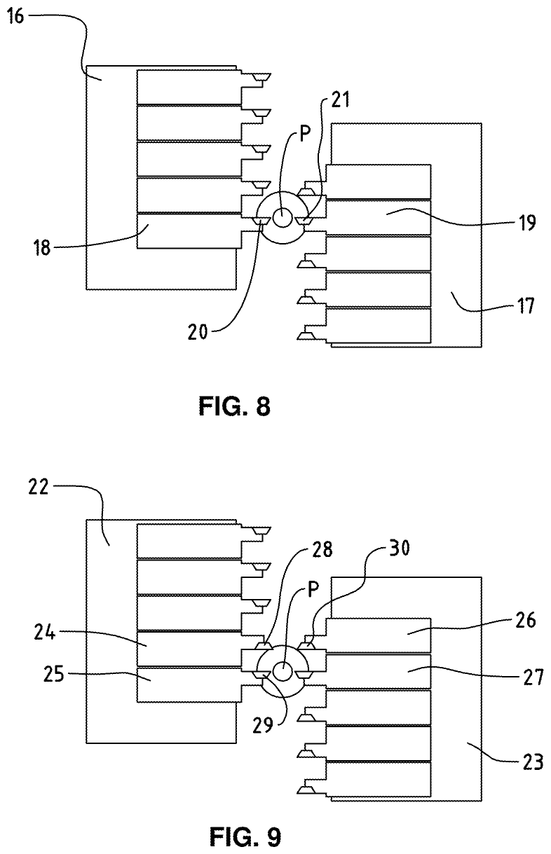

Represented in FIG. 8 are two tool systems 16, 17, each comprising a plurality of tool holders 18, 19. At least two tools 20, 21 are provided for producing a thread; the first cutting edge is then located on a first tool 20 carried by a tool holder 18 mounted on a first tool system 16 and the second cutting edge on a second tool 21 carried by a tool holder 19 mounted on a second tool system 17. The two tools 20, 21 are preferably diametrically opposed.

The passage from the first cutting edge to the second cutting edge is carried out by means of small movements: the first for the removal of the first tool 20 carrying the first cutting edge and the second for the approach of the second tool 21 carrying the second cutting edge of the piece P. These movements can even be combined if it is the workpiece spindle which does the moving.

In FIG. 9, an embodiment for the method according to the first embodiment of the invention calls upon two tool systems 22, 23, on each of which are mounted two tool holders 24, 25 and 26, 27, each tool holder 24, 25, 26, 27 carrying a tool 28, 29, 30, 31 equipped with a cutting edge intended to produce a threading.

During the machining, two preferably diametrically opposed tools 29, 30 or 28, 31 simultaneously machine the piece P.

In one direction of rotation of the workpiece P, the cutting edges of the tools 29, 30 are involved, and in the other direction, the cutting edges of the tools 28, 31.

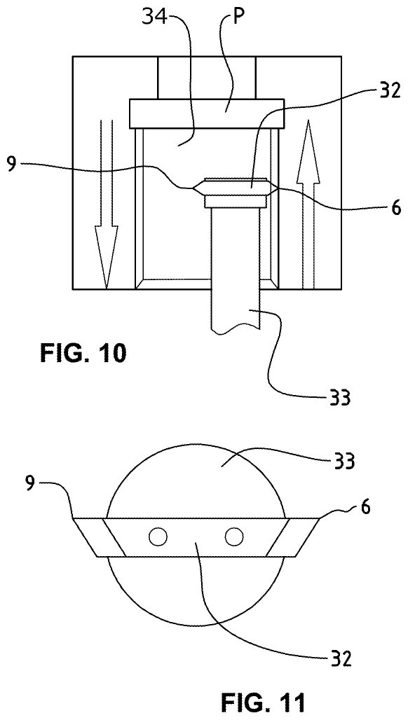

FIGS. 10 and 11 concern the production of an internal threading.

Seen in FIG. 10 is a tool 32 carrying two cutting edges 6, 9 allowing the interior of a bore 34 to be threaded.

As can be deduced from FIG. 10, in one direction of relative longitudinal displacement of the workpiece P with respect to the tool 32, only one edge 6 is active, while in the other direction of longitudinal (axial) displacement, the other edge 9 is active. Each change in the direction of longitudinal displacement corresponds to a change in the direction of rotation of the piece P and a radial displacement of the tool 32 and its tool holder 33.

For producing a threading on a conical or frustoconical piece, the movement of relative longitudinal displacement of the tool for digging the thread is accompanied by a relative radial movement of the tool which follows the surface to be threaded during the “outward” movement similar to that symbolized by the arrow L in FIG. 2a, and then a reverse radial movement during the “return” movement similar to that symbolized by the arrow M in FIG. 4a.

It goes without saying that the method works in any plane depending on the orientation of the tool systems. For example, the aforementioned horizontal movements could be vertical or diagonal.

Thus, thanks to the invention, it is possible to reduce the threading time compared with a threading of the prior art.

Of course the time saved differs greatly from one operation to another, but trials have shown that it is possible to reduce the threading time by 30%.

These time savings are determined in particular by the following elements:
the material of the piece to be machined,
the time for changing of cutting edge and/or the time for reversing the direction of rotation of the spindle/mandrel,
the number of passes, and
the length of the threading.

1. A method of making a thread on a cylindrical, conical or frustoconical piece to be machined, comprising the steps of:
a) driving in rotation the piece to be machined in one rotational direction,
b) carrying out a relative displacement of a first cutting edge of a tool relative to the piece to be machined until the first cutting edge is flush with a surface of the piece to be threaded at a beginning of a section thereof to be threaded,
c) carrying out a relative displacement of the tool relative to the piece so that the first cutting edge machines the piece,
d) carrying out a relative displacement of the tool along a longitudinal axis of the piece to be machined, in one axial direction until an end of the section to be threaded, so that the first cutting edge machines a thread in the piece,
e) moving away, by a relative displacement, the first cutting edge of the tool from the piece to be machined,
f) reversing rotation of the piece to be machined to drive the piece in rotation in a second rotational direction opposite to the one rotational direction, while positioning or not a second cutting edge,
g) moving, by relative displacement, the second cutting edge towards the piece to be machined until the second cutting edge penetrates a pitch of the thread,
h) carrying out a relative displacement of the second cutting edge relative to the piece to be machined so that it continues machining of the thread in the piece,
i) carrying out a relative displacement of the second cutting edge in a second axial direction opposite to the one axial direction, until the beginning of the section to be threaded,
j) moving, by a relative displacement, the second cutting edge away from the piece to be machined,
k) reversing the rotation of the piece to be machined, while positioning or not the first cutting edge, then
l) repeating steps b) to k), while continuing the machining of the thread, until the thread reaches its final dimensions, while positioning the first cutting edge in step b) in such a way that it penetrates the thread pitch already machined.

2. The method according to claim 1, wherein the first and second cutting edges are located on the same tool.

3. The method according to claim 1, wherein the first cutting edge is located on a first tool and the second cutting edge on a second tool.

4. The method according to claim 3, wherein the first tool is carried by a first tool holder and the second tool is carried by a second tool holder.

5. The method according to claim 4, wherein the first tool holder and the second tool holder are mounted on the same tool set.

6. The method according to claim 4, wherein the first tool holder is mounted on a first tool set and the second tool holder is mounted on a second tool set.

7. The method according to claim 5, wherein a third tool with a third cutting edge and a fourth tool with a fourth cutting edge are provided on a second tool set, the first and third tools operating simultaneously and in the same manner, just as do the second and fourth tools.

8. The method according to claim 1, wherein, in the case of a conical or frustoconical workpiece, the movement of relative longitudinal displacement of the tool for digging the thread is accompanied by a relative radial movement of the tool which follows the surface to be threaded, during step d), and then by a reverse radial movement during step h).

9. The method according to claim 1, said thread being an external thread.

10. The method according to claim 1, said thread being an internal thread.
